(19) United States
(12) Patent Application Publication
(10) Pub. No.: US 2026/0281680 A1
(43) Pub. Date: Sep. 17, 2026

(54) DATA PROCESSING METHOD AND SYSTEM FOR NEAR-FIELD WIRELESS TRANSMISSION

(71) Applicant: GuangZhou Dazzle View Intelligent Technology Co., Ltd., Guangzhou (CN)

(72) Inventors: Youxing WANG, Guangzhou (CN); Hui LIU, Guangzhou (CN); Huiting HE, Guangzhou (CN)

(73) Assignee: GuangZhou Dazzle View Intelligent Technology Co., Ltd., Guangzhou (CN)

(21) Appl. No.: 19/569,211

(22) Filed: Mar. 17, 2026

(30) Foreign Application Priority Data
Mar. 17, 2025 (CN) 202510307310.6

(51) Int. Cl. H04W 4/80; H04L 1/00

(52) U.S. Cl. CPC H04W 4/80; H04L 1/0042

(57) ABSTRACT

A data processing method includes: acquiring spectral features and wireless environmental features of a short-range communication area; selecting at least one candidate channel according to the spectral features, and determining an optimal operating channel according to the wireless environmental features; determining an initial channel coding strategy according to state features of the optimal operating channel, adjusting the initial channel coding strategy based on the wireless environmental features, and acquiring an optimal channel coding strategy; inputting the wireless environmental features and the state features of the optimal operating channel into a pre-constructed modulation prediction model, and outputting an optimal signal modulation mode; and sequentially and correspondingly performing data coding, signal modulation, and signal sending on data to be sent by using the optimal channel coding strategy, the optimal signal modulation mode, and the optimal operating channel.

### CROSS-REFERENCE TO RELATED APPLICATIONS

This application claims priority to Chinese Patent Application No. 202510307310.6, filed on Mar. 17, 2025, the content of which is incorporated herein by reference in its entirety.

### TECHNICAL FIELD

The present disclosure relates to the field of wireless communication technology, and in particular, to a data processing method and system for near-field wireless transmission.

### BACKGROUND

With the rapid development of wireless communication technology, the near-field wireless transmission technology has been widely applied in numerous fields, such as mobile payment, smart home, and Internet of Things communication, owing to its high efficiency and convenience. However, during the process of near-field wireless transmission, the reliability and efficiency of data transmission are often affected by various environmental factors, such as the occupation of spectrum resources, the complexity of wireless environments, and electromagnetic interference. Therefore, how to dynamically adjust transmission strategies according to real-time environmental parameters to achieve optimized data transmission has become a critical problem that urgently needs to be solved in the current near-field wireless transmission technology.

Conventional data processing methods for near-field wireless transmission typically use fixed channels, coding strategies, and modulation modes, lacking dynamic adaptability to the environmental parameters. These methods may perform well in relatively stable environments, but often lead to problems such as low data transmission efficiency and increased bit error rates in complex and variable wireless environments. Especially in scenarios with scarce spectrum resources and severe electromagnetic interference, conventional fixed transmission strategies struggle to meet requirements for the reliability and real-time performance of data transmission.

Therefore, there is a need to provide a data processing method and system for near-field wireless transmission to solve the above-mentioned technical problems.

### SUMMARY

In order to solve the above-mentioned technical problems, the present disclosure provides a data processing method and system for near-field wireless transmission. By acquiring environmental parameters of a short-range communication area in real time, including spectral features and wireless environmental features, and dynamically selecting an optimal operating channel, an optimal channel coding strategy, and an optimal signal modulation mode according to these parameters, the method can fully utilize environmental information to achieve dynamic optimization of transmission strategies, thereby enhancing reliability and efficiency of data transmission.

The present disclosure provides a data processing method for near-field wireless transmission. The method includes the following steps:
an environmental parameter acquiring device acquires environmental parameters of a short-range communication area, where the environmental parameters include spectral features and wireless environmental features of the short-range communication area;
a channel determination device selects at least one candidate channel according to the spectral features and determines an optimal operating channel from the at least one candidate channel based on the wireless environmental features of the short-range communication area;
a strategy determination device determines an initial channel coding strategy according to state features of the optimal operating channel and adjusts the initial channel coding strategy based on the wireless environmental features of the short-range communication area to acquire an optimal channel coding strategy;
a modulation mode determination device inputs the wireless environmental features of the short-range communication area and the state features of the optimal operating channel into a pre-constructed modulation prediction model to output an optimal signal modulation mode; and
a sending device sequentially and correspondingly performs data coding, signal modulation, and signal sending on data to be sent by using the optimal channel coding strategy, the optimal signal modulation mode, and the optimal operating channel.

Preferably, the acquisition of environmental parameters of a short-range communication area includes:
collecting and analyzing the spectral features within the short-range communication area, where the spectral features include available frequency bands, spectrum occupancy states, and signal interference intensities; and
measuring and evaluating the wireless environmental features within the short-range communication area, where the wireless environmental features include a path loss value of a signal, a multipath effect parameter value of the signal, a level of obstruction of a signal transmission path by an obstacle, and an electromagnetic environment interference intensity.

Preferably, the step that a channel determination device selects at least one candidate channel according to the spectral features and determines an optimal operating channel from the at least one candidate channel based on the wireless environmental features of the short-range communication area includes:
screening out a candidate channel set that meets preset spectrum conditions based on the available frequency bands, the spectrum occupancy states, and the signal interference intensities in the spectral features, where the preset spectrum conditions include determining whether a channel is available, whether the spectrum occupancy rate of the channel is less than a preset occupancy rate threshold, and whether the signal interference intensity of the channel is less than a preset interference threshold;
performing indicator evaluation on the candidate channel set according to a plurality of evaluation indicators determined by the wireless environmental features, to obtain an evaluation result; and
determining the optimal operating channel from the candidate channel set through a weighted scoring method based on the evaluation result of the wireless environmental features.

Preferably, processing the evaluation indicators includes:
measuring and calculating a path loss value for each candidate channel, where the path loss value is negatively correlated with a channel score;
analyzing a multipath effect parameter value for each candidate channel, where the multipath effect parameter value is negatively correlated with the channel score;
simulating a signal propagation path of each candidate channel by using a geographic information system in combination with a building layout map, and evaluating a level of obstruction of a signal transmission path by an obstacle, where the obstruction level is negatively correlated with the channel score; and
monitoring an electromagnetic environment interference intensity for each candidate channel, where the electromagnetic environment interference intensity is negatively correlated with the channel score.

Preferably, the determining an optimal operating channel from the candidate channel set through a weighted scoring method based on the evaluation result of the wireless environmental features includes:
pre-allocating a corresponding weight coefficient for each evaluation indicator;
for each candidate channel, calculating a weighted score of the candidate channel using the following formula:

$${S}_{i} = {ω}_{1} \cdot {P}_{i} + {ω}_{2} \cdot {M}_{i} + {ω}_{3} \cdot {O}_{i} + {ω}_{4} \cdot {I}_{i}$$

where Sᵢ represents a weighted score of an i-th candidate channel, Pᵢ represents a path loss value of the i-th candidate channel, Mᵢ represents a multipath effect parameter value of the i-th candidate channel, Oᵢ represents an obstruction level of the i-th candidate channel, Iᵢ represents an electromagnetic environment interference intensity of the i-th candidate channel, and ω₁, ω₂, ω₃, and ω₄ respectively represent weight coefficients for the path loss value, the multipath effect parameter value, the obstruction level, and the electromagnetic environment interference intensity; and
selecting a channel with the highest weighted score from all the candidate channels as the optimal operating channel.

Preferably, the step that a strategy determination device determines an initial channel coding strategy according to state features of the optimal operating channel and adjusts the initial channel coding strategy based on the wireless environmental features of the short-range communication area to acquire an optimal channel coding strategy includes:
preliminarily selecting a combination of coding rates and coding lengths from a preset mapping table as the initial channel coding strategy based on spectrum efficiency, a bit error rate, and signal stability of the optimal operating channel, where the preset mapping table is pre-established according to an empirical relationship between channel state features and coding parameters; and
adjusting a coding rate and a coding length of the initial channel coding strategy according to the path loss value, the multipath effect parameter value, the obstruction level, and the electromagnetic environment interference intensity to obtain the optimal channel coding strategy with the adjusted coding rate and coding length.

Preferably, the coding rate and the coding length are adjusted according to the following formulas:

$${R}_{2} = {R}_{1} \cdot ( 1 - {α}_{1} \cdot \frac{P}{{P}_{max}} - {α}_{2} \cdot \frac{M}{{M}_{max}} - {α}_{3} \cdot \frac{O}{{O}_{max}} - {α}_{4} \cdot \frac{1}{{I}_{max}} )$$

$${L}_{2} = {L}_{1} \cdot ( 1 + {β}_{1} \cdot \frac{P}{{p}_{max}} + {β}_{2} \cdot \frac{M}{{M}_{max}} + {β}_{3} \cdot \frac{O}{{O}_{max}} + {β}_{4} \cdot \frac{1}{{I}_{max}} )$$

where R₂ and R₁ represent coding rates before and after the adjustment respectively, L₂ and L₁ represent coding lengths before and after the adjustment respectively, P, M, O, and I represent the path loss value, the multipath effect parameter value, the obstruction level, and the electromagnetic environment interference intensity respectively, with values equal to Pᵢ, Mᵢ, Oᵢ, and Iᵢ respectively, α₁, α₂, α₃, and α₄ represent adjustment coefficients corresponding to the coding rate adjustment, β₁, β₂, β₃, and β₄ represent adjustment coefficients corresponding to the coding length adjustment, and Pₘₐₓ, Mₘₐₓ, Oₘₐₓ, and Iₘₐₓ are maximum allowable values of the path loss value, the multipath effect parameter value, the obstruction level, and the electromagnetic environment interference intensity, respectively.

Preferably, the step that a modulation mode determination device inputs the wireless environmental features of the short-range communication area and the state features of the optimal operating channel into a pre-constructed modulation prediction model to output an optimal signal modulation mode includes:
inputting the wireless environmental features and the state features of the optimal operating channel as an input vector into the pre-constructed modulation prediction model, and according to the inputted input vector, calculating, by the modulation prediction model, an applicable score for each modulation mode, and selecting the modulation mode with the highest score as the optimal signal modulation mode, where the modulation prediction model is a machine learning model that learns a mapping relationship between the wireless environmental features, the channel state features, and the optimal signal modulation mode.

Preferably, the step that a sending device sequentially and correspondingly performs data coding, signal modulation, and signal sending on data to be sent by using the optimal channel coding strategy, the optimal signal modulation mode, and the optimal operating channel includes:
coding the data to be sent according to the determined optimal channel coding strategy;
converting the coded data into a signal form suitable for transmission on the selected optimal operating channel by using the determined optimal signal modulation mode; and
sending a modulated signal to a receiving terminal through the optimal operating channel.

The present disclosure further provides a data processing system for near-field wireless transmission. The system includes:
an environmental parameter acquiring device, configured to acquire environmental parameters of a short-range communication area, where the environmental parameters include spectral features and wireless environmental features of the short-range communication area;
a channel determination device, configured to select at least one candidate channel according to the spectral features and determine an optimal operating channel from the at least one candidate channel based on the wireless environmental features of the short-range communication area;
a strategy determination device, configured to determine an initial channel coding strategy according to state features of the optimal operating channel and adjust the initial channel coding strategy based on the wireless environmental features of the short-range communication area to acquire an optimal channel coding strategy;
a modulation mode determination device, configured to input the wireless environmental features of the short-range communication area and the state features of the optimal operating channel into a pre-constructed modulation prediction model to output an optimal signal modulation mode; and
a sending device, configured to sequentially and correspondingly perform data coding, signal modulation, and signal sending on data to be sent by using the optimal channel coding strategy, the optimal signal modulation mode, and the optimal operating channel.

Compared with the related art, the data processing method and system for near-field wireless transmission according to the present disclosure have the following beneficial effects.

According to the present disclosure, first, the candidate channel set that meets the preset spectrum conditions is screened out by collecting and analyzing the spectral features within the short-range communication area. Then, the candidate channels are comprehensively evaluated in combination with the wireless environmental features such as a path loss value of a signal, a multipath effect parameter value, a level of obstruction of a signal transmission path by an obstacle, and an electromagnetic environment interference intensity, thereby determining the optimal operating channel. After determining the optimal operating channel, the present disclosure further preliminarily selects the initial channel coding strategy according to the state features of the channel, such as the spectrum efficiency, the bit error rate, and the signal stability, and adjusts the coding rate and the coding length based on the wireless environmental features, thereby obtaining the optimal channel coding strategy. Finally, the wireless environmental features and the state features of the optimal operating channel are inputted into the pre-constructed modulation prediction model, to output the optimal signal modulation mode. By utilizing the optimal channel coding strategy, the optimal signal modulation mode, and the optimal operating channel, the data to be sent is coded, modulated, and sent, thereby achieving optimization of data transmission.

In summary, the data processing method for near-field wireless transmission according to the present disclosure effectively enhances the reliability and efficiency of data transmission by acquiring the environmental parameters in real time and dynamically adjusting the transmission strategies.

### BRIEF DESCRIPTION OF THE DRAWINGS

FIG. 1 is a flowchart of a data processing method for near-field wireless transmission according to the present disclosure.

FIG. 2 is a flowchart of acquiring environmental parameters of a short-range communication area according to the present disclosure.

FIG. 3 is a flowchart of determining an optimal operating channel according to the present disclosure.

FIG. 4 is a flowchart of acquiring an optimal channel coding strategy according to the present disclosure.

FIG. 5 is a flowchart of performing data coding, signal modulation, and signal sending according to the present disclosure.

FIG. 6 is a structural diagram of devices of a data processing system for near-field wireless transmission according to the present disclosure.

### DETAILED DESCRIPTION OF THE EMBODIMENTS

The present disclosure is further described in detail in combination with accompanying drawings and embodiments. It should be understood that specific embodiments described herein are merely used for explaining the present disclosure rather than limiting the present disclosure. In addition, it should be further noted that for ease of description, the accompanying drawings only illustrate part of structures relevant to the present disclosure rather than all structures. Additionally, in a case of no conflict, the embodiments of the present disclosure and features of the embodiments may be combined with each other.

In addition, it should be further noted that for ease of description, the accompanying drawings only illustrate parts relevant to the present disclosure rather than all content. Before exemplary embodiments are discussed in more detail, it should be noted that some exemplary embodiments are described as processes or methods described as flowcharts. Although the flowcharts describe operations (or steps) as sequential processes, many of these operations may be implemented in parallel, concurrently, or simultaneously. In addition, a sequence of the operations may be re-arranged. The process may be terminated when the operations are completed, additional steps not included in the accompanying drawings may also exist. The process may correspond to a method, a function, a procedure, a subroutine, a subprogram, etc.

### Embodiment 1

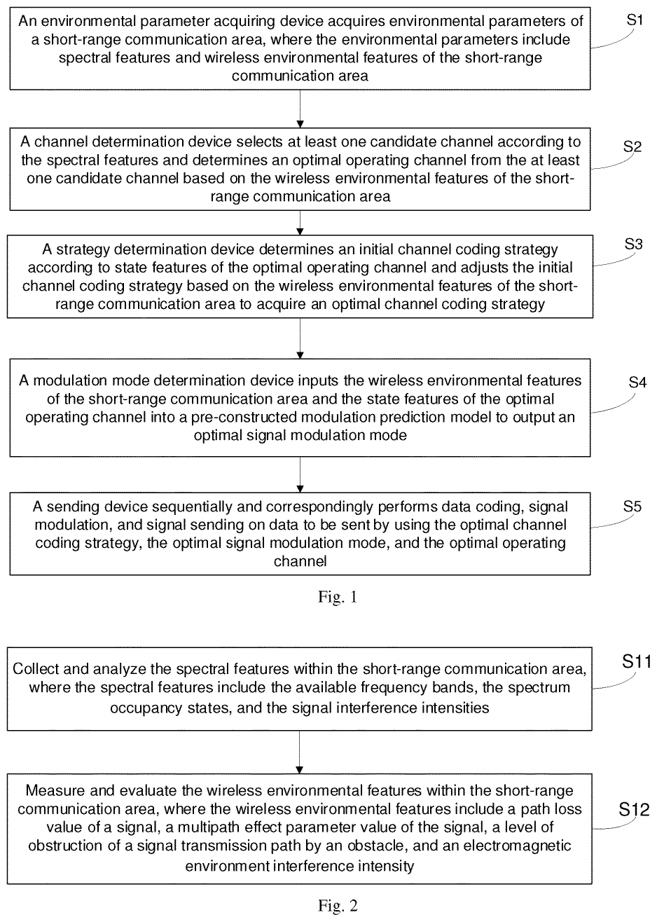

The present disclosure provides a data processing method for near-field wireless transmission. Referring to FIG. 1, the method includes the following steps:
S1: An environmental parameter acquiring device acquires environmental parameters of a short-range communication area, where the environmental parameters include spectral features and wireless environmental features of the short-range communication area.

In the data processing method for near-field wireless transmission, acquiring the environmental parameters of the short-range communication area is a crucial first step. These environmental parameters include the spectral features and the wireless environmental features, which directly affect the selection of channels, coding strategies, and modulation modes. Specifically, the spectral features provide information on available frequency bands, spectrum occupancy states, and signal interference intensities, which is crucial for screening a suitable candidate channel. On the other hand, the wireless environmental features such as a path loss, a multipath effect, an obstacle obstruction level, and an electromagnetic interference intensity help evaluate the quality of each candidate channel, thereby determining an optimal operating channel. By accurately acquiring the information, the reliability and efficiency of data transmission may be significantly improved. Specifically, referring to FIG. 2, step S1 includes the following steps:
S11: Collect and analyze the spectral features within the short-range communication area, where the spectral features include the available frequency bands, the spectrum occupancy states, and the signal interference intensities.

In this embodiment, the short-range communication area is scanned through a spectrum analysis device (including but not limited to a spectrum analyzer or a software-defined radio device) to collect spectrum data for all the available frequency bands within the area. The data includes a frequency range, a bandwidth, a current usage condition, and the presence of interfering signals for each frequency band. Subsequently, the spectrum data is analyzed to recognize which frequency bands are unoccupied or only slightly occupied, and the signal interference intensity for each frequency band is calculated. Based on these analysis results, a spectrum database is established to record detailed information about each frequency band, including a spectrum occupancy rate, an interference level, etc.

Additionally, frequency bands that meet requirements are also screened out as candidate frequency bands based on preset spectrum conditions (the spectrum occupancy rate below a certain threshold and the interference intensity less than a certain level).

By collecting and analyzing the spectral features, frequency bands suitable for wireless transmission can be effectively recognized, avoiding waste of spectrum resources and unnecessary interference, which not only improves a spectrum utilization rate but also provides a reliable basis for channel selection in subsequent steps. Additionally, the method can also adapt to dynamically changing spectrum environments, ensuring efficient data transmission even when spectrum usage conditions change.
S12: Measure and evaluate the wireless environmental features within the short-range communication area, where the wireless environmental features include a path loss value of a signal, a multipath effect parameter value of the signal, a level of obstruction of a signal transmission path by an obstacle, and an electromagnetic environment interference intensity.

In this embodiment, to understand the wireless environmental features of the short-range communication area, a series of detailed measurements and evaluation operations are required. First, the path loss is evaluated by using a method of combining a wireless signal propagation model and an actual measurement. The path loss value may be calculated by transmitting a test signal with known power and measuring an intensity of the received signal at a receiving terminal. Then, the multipath effect parameter value is analyzed by using a multipath detection technology. A specific parameter of the multipath effect is determined by sending a specific detection signal and analyzing a reflection path thereof. In this application, the multipath effect parameter value is represented by a root-mean-square delay spread value. For evaluating the obstacle obstruction level, potential physical obstacles and the impact on signal propagation are recognized by simulating signal propagation paths at different positions in combination with a geographic information system (GIS) and a building layout map. Finally, an electromagnetic environment monitoring device is used to detect the electromagnetic interference intensity, record an interference signal intensity across each frequency band, and compare the interference signal intensity with a standard interference threshold.

A comprehensive and accurate description of the wireless environment can be obtained through a detailed measurement and evaluation of the wireless environmental features, which not only facilitates accurate evaluation of the quality of each candidate channel but also provides a critical basis for subsequent weighted scoring and channel selection. Particularly for common problems such as the multipath effect and obstacle obstruction in complex urban or industrial environments, this meticulous analysis method can significantly enhance the stability and reliability of data transmission.
S2: A channel determination device selects at least one candidate channel according to the spectral features and determines an optimal operating channel from the at least one candidate channel based on the wireless environmental features of the short-range communication area.

In this application, this step directly influences the subsequent selection of coding strategies and modulation modes, ultimately affecting the quality and efficiency of data transmission. Specifically, by analyzing the spectral features (e.g., the available frequency bands, the spectrum occupancy states, and the signal interference intensities), a suitable candidate channel set may be screened out. The quality of each candidate channel may be evaluated by further combing the wireless environmental features (e.g., the path loss, the multipath effect, the obstacle obstruction level, and the electromagnetic interference intensity), thereby selecting the optimal operating channel most suitable for a current communication environment.

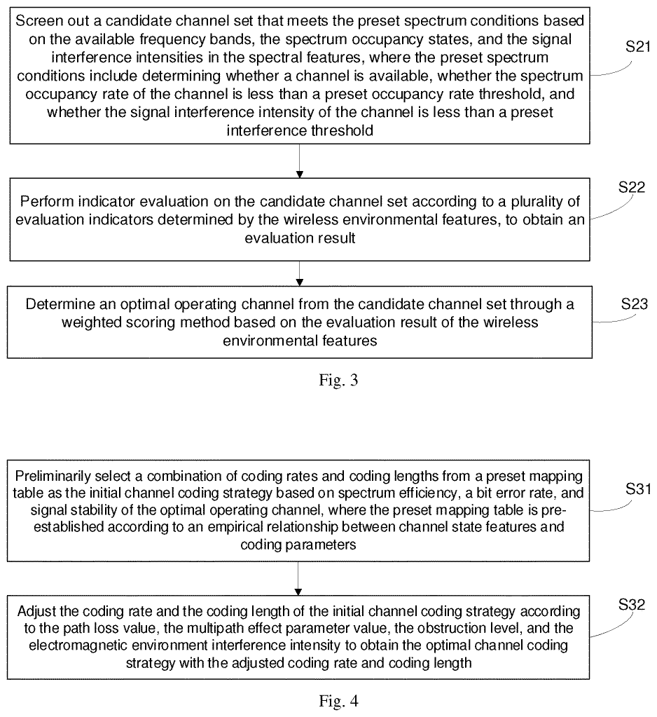

Specifically, referring to FIG. 3, step S2 includes the following steps:
S21: Screen out a candidate channel set that meets the preset spectrum conditions based on the available frequency bands, the spectrum occupancy states, and the signal interference intensities in the spectral features, where the preset spectrum conditions include determining whether a channel is available, whether the spectrum occupancy rate of the channel is less than a preset occupancy rate threshold, and whether the signal interference intensity of the channel is less than a preset interference threshold.

After the spectral features (including the available frequency bands, the spectrum occupancy states, and the signal interference intensities) of the short-range communication area is acquired, the data is screened according to the preset spectrum conditions to determine the candidate channel set. Specific implementation steps are as follows:
Channel availability determination: First, whether each frequency band complies with legal and technical regulatory requirements needs to be confirmed. For example, some frequency bands may be subject to strict regulation by national or regional radio regulatory authorities and may only be permitted for use under specific conditions. In addition, technical specifications and supported frequency band ranges of the device also need to be considered to ensure compatibility between the selected frequency band and the device.
Spectrum occupancy rate threshold: A maximum allowable spectrum occupancy rate is defined, such as not exceeding 30%, to ensure that the selected frequency band has sufficient idle resources for transmission.
Signal interference intensity threshold: A maximum allowable signal interference intensity level is set, such as below-85 dBm, to guarantee that the signal quality is not overly affected by external interference.

Based on the standards set above, all the available frequency bands may be preliminarily screened. This step primarily relies on the previously collected spectrum data, and the determination is made by comparing an actual occupancy rate and interference intensity of each frequency band with set thresholds.

For frequency bands where the spectrum occupancy rate is below the set occupancy rate threshold and the signal interference intensity is also below the set interference threshold, further checks are performed to determine whether those frequency bands are compliant with legal, regulatory, and technical specifications. If a frequency band meets standards about the spectrum occupancy rate and the interference intensity but fails to comply with local radio regulatory requirements or is not supported by the device, the frequency band should not be considered an available channel.

Finally, frequency bands that pass all the above-mentioned checks are added to the candidate channel set. This set includes all frequency bands most suitable for wireless transmission under current conditions.

The method can enable the effective screening of the most suitable candidate channel set from numerous available frequency bands, taking into account not only the spectrum occupancy rate and the signal interference intensity but also fully considering requirements of laws, regulations, and technical specifications, thereby avoiding the waste of the spectrum resources and unnecessary interference. This strategy not only increases the spectrum utilization rate but also provides a reliable basis for selecting the optimal operating channel in subsequent steps, and meanwhile adapts to dynamically changing demands, ensuring efficient data transmission even when the spectrum usage conditions change.
S22: Perform indicator evaluation on the candidate channel set according to a plurality of evaluation indicators determined by the wireless environmental features, to obtain an evaluation result.

In this embodiment, to accurately evaluate the quality of each candidate channel, the plurality of evaluation indicators determined by the plurality of wireless environmental features need to be considered. Specific steps are as below:
Path loss evaluation: A test signal with known power is transmitted, an intensity of the received signal is measured at the receiving terminal, and a path loss value is calculated. A lower path loss value indicates a shorter signal propagation path and less signal attenuation.
Multipath effect parameter evaluation: A specific detection signal is sent by using the multipath detection technology, and a reflection path of the detection signal is analyzed to determine specific parameters of the multipath effect. In this embodiment, the root-mean-square delay spread (RMS Delay Spread) is selected as a key parameter of the multipath effect. A smaller root-mean-square delay spread indicates a milder multipath effect and better channel quality.
Evaluation of obstacle obstruction level: The geographic information system (GIS) and the building layout map are combined to simulate signal propagation paths at different positions, recognizing potential physical obstacles and the impact on signal propagation. A lower obstacle obstruction level indicates a smoother signal transmission path and higher channel quality.
Electromagnetic interference intensity monitoring: The interference signal intensity across each frequency band is detected by using the electromagnetic environment monitoring device and compared with the standard interference threshold. A lower electromagnetic interference intensity indicates fewer external interferences affecting the channel and better channel quality.

For each evaluation indicator, a corresponding score is given according to a value of the evaluation indicator. For example, the path loss value, the multipath effect parameter value, the obstacle obstruction level, and the electromagnetic interference intensity are all negatively correlated with a channel score. That is, the smaller these values are, the higher the channel score.

The detailed measurement and evaluation of the wireless environmental features not only facilitate accurate evaluation of the quality of each candidate channel but also provide a critical basis for subsequent weighted scoring and channel selection.
S23: Determine an optimal operating channel from the candidate channel set through a weighted scoring method based on the evaluation result of the wireless environmental features.

In this embodiment, to determine the optimal operating channel from the candidate channel set, the weighted scoring method is used. Specific steps are as below:
Weight coefficient allocation: A corresponding weight coefficient is pre-allocated to each evaluation indicator (the path loss value, the multipath effect parameter value, the obstacle obstruction level, and the electromagnetic interference intensity). These weight coefficients may be manually adjusted according to requirements of an actual application scenario to balance the impact of different factors on the channel quality.
Weighted score calculation: For each candidate channel, a weighted score of the candidate channel is calculated using the following formula.

$${S}_{i} = {ω}_{1} \cdot {P}_{i} + {ω}_{2} \cdot {M}_{i} + {ω}_{3} \cdot {O}_{i} + {ω}_{4} \cdot {I}_{i}$$

Sᵢ represents a weighted score of an i-th candidate channel, Pᵢ represents a path loss value of the i-th candidate channel, Mᵢ represents a multipath effect parameter value of the i-th candidate channel, Oᵢ represents an obstruction level of the i-th candidate channel, Iᵢ represents an electromagnetic environment interference intensity of the i-th candidate channel, and ω₁, ω₂, ω₃, and ω₄ respectively represent weight coefficients for the path loss value, the multipath effect parameter value, the obstruction level, and the electromagnetic environment interference intensity.
c. A channel with the highest weighted score is selected from all the candidate channels as the optimal operating channel.

Through the weighted scoring method, the plurality of wireless environmental feature evaluation indicators can be comprehensively considered, and comprehensive scoring can be performed according to preset weight coefficients. The method can not only enable the accurate evaluation of the quality of each candidate channel, but also achieve the selection of the optimal operating channel most suitable for current communication requirements in a complex and variable wireless environment, thereby significantly improving the reliability and efficiency of data transmission.
S3: A strategy determination device determines an initial channel coding strategy according to state features of the optimal operating channel and adjusts the initial channel coding strategy based on the wireless environmental features of the short-range communication area to acquire an optimal channel coding strategy.

After the optimal operating channel is determined, the next step is to formulate the initial channel coding strategy according to the state features of the channel and adjust the strategy according to the wireless environmental features of the short-range communication area to obtain the optimal channel coding strategy. The selection of the channel coding strategy directly affects key performance indicators such as reliability of data transmission, a bit error rate, and spectrum efficiency. Through reasonable selection of a coding rate and a coding length, the stability and efficiency of data transmission may be effectively improved, especially in the complex and variable wireless environment.

Specifically, referring to FIG. 4, step S3 includes the following steps:
S31: Preliminarily select a combination of coding rates and coding lengths from a preset mapping table as the initial channel coding strategy based on spectrum efficiency, a bit error rate, and signal stability of the optimal operating channel, where the preset mapping table is pre-established according to an empirical relationship between channel state features and coding parameters.

In this embodiment, a set of initial coding rates and coding lengths is selected from a pre-established empirical mapping table according to the state features (the spectrum efficiency, the bit error rate, and the signal stability) of the optimal operating channel. The mapping table is typically constructed based on extensive experimental data and historical experience, and records optimal coding parameter combinations under different channel states. For example, under conditions of a high bit error rate but favorable spectrum efficiency, a low coding rate and a long coding length may be selected to enhance an error correction capability. Conversely, under a low bit error rate and stable channel conditions, a high coding rate and a short coding length may be selected to improve transmission efficiency.
Spectrum efficiency evaluation: A suitable coding rate is determined by measuring an actual spectrum utilization rate of the optimal operating channel, namely, the amount of data transmitted per unit bandwidth.
Bit error rate analysis: A coding length that can provide a sufficient error correction capability is selected according to a bit error rate condition of the channel. If the bit error rate is high, redundant information needs to be added to ensure data integrity.
Signal stability consideration: The signal stability of the channel is taken into account, including a fluctuation condition over time. For a channel with poor stability, a more conservative coding strategy is typically required to address potential burst errors.

Based on the above-mentioned analysis results, a matched combination of coding rates and coding lengths is selected from the preset mapping table as the initial channel coding strategy.

Through the method, a group of relatively optimized initial settings can be rapidly found from a large number of possible coding parameter combinations, not only improving design efficiency but also providing a basis for subsequent fine-tuning. Further, the mapping table constructed based on the experience and experimental data ensures that the selected strategy can achieve favorable performance in most cases.
S32: Adjust the coding rate and the coding length of the initial channel coding strategy according to the path loss value, the multipath effect parameter value, the obstruction level, and the electromagnetic environment interference intensity to obtain the optimal channel coding strategy with the adjusted coding rate and coding length.

In this embodiment, the following two formulas are used to dynamically adjust the coding rate and the coding length to adapt to different wireless environment conditions. The adjustment of the coding rate primarily aims to still maintain a certain level of transmission efficiency under severe conditions, while the adjustment of the coding length aims to improve the reliability and anti-interference capability of data transmission. The method can better adapt to complex wireless communication environments and optimize data transmission performance.

The adjustment of the coding rate and the coding length is performed according to the following formulas:

$${R}_{2} = {R}_{1} \cdot ( 1 - {α}_{1} \cdot \frac{P}{{P}_{max}} - {α}_{2} \cdot \frac{M}{{M}_{max}} - {α}_{3} \cdot \frac{O}{{O}_{max}} - {α}_{4} \cdot \frac{1}{{I}_{max}} )$$

$${L}_{2} = {L}_{1} \cdot ( 1 + {β}_{1} \cdot \frac{P}{{p}_{max}} + {β}_{2} \cdot \frac{M}{{M}_{max}} + {β}_{3} \cdot \frac{O}{{O}_{max}} + {β}_{4} \cdot \frac{1}{{I}_{max}} )$$

R₂ and R₁ represent coding rates before and after the adjustment respectively, L₂ and L₁ represent coding lengths before and after the adjustment respectively, P, M, O, and I represent the path loss value, the multipath effect parameter value, the obstruction level, and the electromagnetic environment interference intensity respectively, with values equal to Pᵢ, Mᵢ, Oᵢ, and Iᵢ respectively, and α₁, α₂, α₃, and α₄ represent adjustment coefficients corresponding to the coding rate adjustment. These coefficients determine a degree of the impact of each wireless environmental feature on the coding rate, with values ranging from 0 to 1, for controlling a weight of impact of each factor on the coding rate. β₁, β₂, β₃, and β₄ represent adjustment coefficients corresponding to the coding length adjustment. These coefficients determine a degree of the impact of each wireless environmental feature on the coding length, with values greater than 0, for increasing the coding length, thereby improving the reliability of data transmission. Pₘₐₓ, Mₘₐₓ, Oₘₐₓ, and Iₘₐₓ are maximum allowable values of the path loss value, the multipath effect parameter value, the obstruction level, and the electromagnetic environment interference intensity, respectively. These maximum values are used to normalize various wireless environmental features, making them comparable in computation.

In this embodiment, the adjustment formula for the coding rate adapts to poor wireless environment conditions (e.g., a high path loss, a strong multipath effect, severe obstacle obstruction, or high-intensity electromagnetic interference) by reducing the coding rate.

The impact of each wireless environmental feature is normalized, multiplied by the corresponding adjustment coefficient, and then subtracted from 1 to obtain a correction factor. The correction factor is multiplied by the coding rate before the adjustment to obtain the adjusted coding rate. If the impact of a certain wireless environmental feature is significant (e.g., a high path loss), a term corresponding to the feature is larger, resulting in a smaller correction factor and ultimately leading to a reduction in the coding rate. Conversely, if the wireless environment conditions are favorable, the correction factor is close to 1, and the coding rate remains almost unchanged.

The adjustment formula for the coding length enhances the reliability of data transmission by increasing the coding length, especially under poor wireless environment conditions (e.g., a high path loss, a strong multipath effect, severe obstacle obstruction, or high-intensity electromagnetic interference). The impact of each wireless environmental feature is normalized, multiplied by the corresponding adjustment coefficient, and then added to 1 to obtain a correction factor. The correction factor is multiplied by the coding length before the adjustment to obtain the adjusted coding length.

If the impact of a certain wireless environmental feature is significant (e.g., a high path loss), a term corresponding to the feature is larger, resulting in a larger correction factor and ultimately leading to an increase in the coding length. Conversely, if the wireless environment conditions are favorable, the correction factor is close to 1, and the coding length remains almost unchanged.
S4: A modulation mode determination device inputs the wireless environmental features of the short-range communication area and the state features of the optimal operating channel into a pre-constructed modulation prediction model to output an optimal signal modulation mode.

Specifically, step S4 includes the following content:

The wireless environmental features and the state features of the optimal operating channel are used as an input vector to be inputted into the pre-constructed modulation prediction model. According to the inputted input vector, the modulation prediction model calculates an applicable score for each modulation mode and selects the modulation mode with the highest score as the optimal signal modulation mode. The modulation prediction model is a machine learning model that learns a mapping relationship between the wireless environmental features, the channel state features, and the optimal signal modulation mode.

In this embodiment, different wireless environmental features (e.g., the path loss, the multipath effect, the obstacle obstruction level, and the electromagnetic interference intensity) as well as the state features of the optimal operating channel (e.g., the spectrum efficiency, the bit error rate, and the signal stability) all influence the selection of the most suitable modulation mode. By using the machine learning model to predict the optimal signal modulation mode, the feature information may be fully utilized to automatically select a modulation solution that best fits current communication conditions, thereby improving the overall system performance.

To determine the optimal signal modulation mode, the collected wireless environmental features of the short-range communication area (including the path loss value, the multipath effect parameter value, the obstacle obstruction level, and the electromagnetic interference intensity) as well as the state features of the optimal operating channel (e.g., the spectrum efficiency, the bit error rate, and the signal stability) are organized into one input vector and inputted into the pre-trained modulation prediction model.

The wireless environmental features and the state features of the optimal operating channel are used as the input vector. Each element represents a specific value of one of the above-mentioned features.

The modulation prediction model is a pre-trained machine learning model based on a large amount of experimental data and historical experience, which may include, but is not limited to, a support vector machine (SVM), a neural network (NN), or another type of classifier. A model learning process involves performance data of various modulation modes under numerous different conditions, aiming to learn the mapping relationship between the wireless environmental features and the optimal modulation mode.

After the input vector is inputted into the modulation prediction model, the model may calculate one applicable score for each available modulation mode. This score reflects expected performance of a specific modulation mode under given wireless environmental conditions. For example, some modulation modes perform better in high-bit-error-rate environments, while others are more stable in complex multipath environments.

According to applicable scores for all modulation modes, the modulation mode with the highest score is selected as the optimal signal modulation mode, ensuring that the selected modulation mode can adapt to a current wireless communication environment to the greatest extent and provide optimal data transmission performance.
S5: A sending device sequentially and correspondingly performs data coding, signal modulation, and signal sending on data to be sent by using the optimal channel coding strategy, the optimal signal modulation mode, and the optimal operating channel.

After determining the optimal operating channel and selecting the optimal coding strategy and modulation mode, the next step is to apply these selections to an actual data transmission process. Specifically, the data to be sent needs to be coded according to the optimal channel coding strategy. By using the selected optimal signal modulation mode, the coded data is converted into a signal form suitable for transmission on the selected optimal operating channel. Finally, the signal is sent to the receiving terminal through the optimal operating channel. This process ensures that data can be efficiently and reliably transmitted in complex wireless environments.

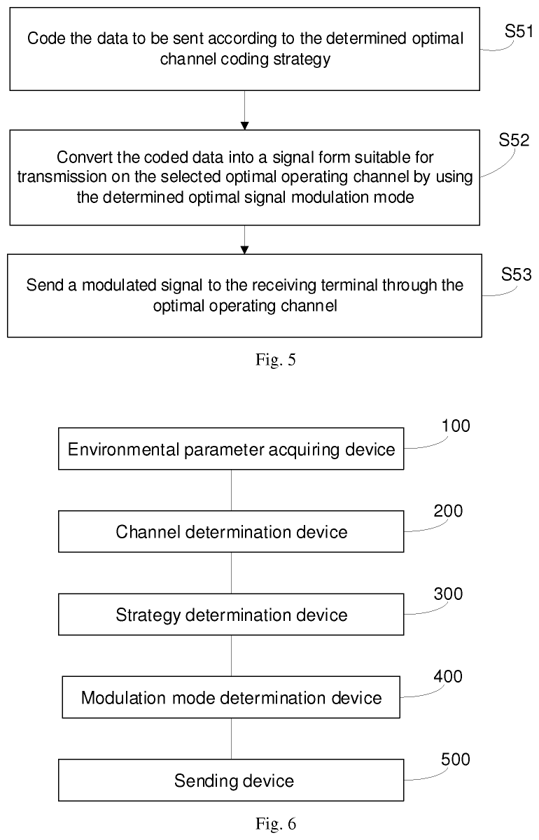

Specifically, referring to FIG. 5, step S5 includes the following steps:
S51: Code the data to be sent according to the determined optimal channel coding strategy.

In this embodiment, the original data to be sent is coded based on the optimal channel coding strategy (including the coding rate and the coding length) determined in the previous steps. The coding process typically includes the following key steps:
Grouping and redundancy addition: According to requirements of the coding length, the data to be sent is divided into a plurality of groups, and appropriate redundant information is added to each group. This step helps improve the reliability of data transmission, especially under channel conditions with high bit error rates or instability.
Error correction coding: Each set of data is coded at a set coding rate by using an error correction coding technology (including but not limited to convolutional coding, Turbo coding, and low-density parity-check (LDPC) coding). The coding rate determines a ratio of original data to redundant information, and a low coding rate means higher redundancy and a stronger error-correcting capability.

Through the above-mentioned steps, optimally coded data streams can be generated. These data streams exhibit high robustness and are capable of maintaining good transmission quality in the complex and variable wireless environments.
S52: Convert the coded data into a signal form suitable for transmission on the selected optimal operating channel by using the determined optimal signal modulation mode.

In this embodiment, after data coding is completed, the next step is to convert the coded data into the signal form suitable for transmission on the selected optimal operating channel according to the optimal signal modulation mode determined in the previous steps. Specific steps are as below:
Suitable modulation solution selection: According to the wireless environmental features and the channel state features, the most suitable modulation mode is selected from the pre-constructed modulation prediction model. The modulation modes include, but are not limited to, QPSK, 16-QAM, and 64-QAM. Different modulation modes have different trade-offs between bandwidth utilization rates and anti-noise performance.
Signal mapping: Map coded bit streams to corresponding constellation points to form baseband signals in a complex form. Exemplarily, in QPSK modulation, every two bits are mapped to one constellation point; whereas in 16-QAM, every four bits are mapped to one constellation point.
Carrier modulation: Load the baseband signals onto high-frequency carriers to form radio frequency signals suitable for propagation in wireless channels.

Through these steps, coded digital information can be converted into an analog signal form suitable for transmission on the selected optimal operating channel, preparing for actual data sending.
S53: Send a modulated signal to the receiving terminal through the optimal operating channel.

In this embodiment, the final step is to send the modulated signal to the receiving terminal through the previously selected optimal operating channel. A specific implementation includes:
sending a modulated radio frequency signal through an antenna, where to ensure that the receiving terminal can correctly demodulate the received signal, a sending terminal also needs to provide necessary synchronization information, including but not limited to preamble codes or training sequences. This information helps a receiver lock the signal and recover the original data accurately.

### Embodiment 2

The present disclosure further provides a data processing system for near-field wireless transmission, for performing a data processing method for near-field wireless transmission. Referring to FIG. 6, the system includes:
an environmental parameter acquiring device 100, configured to acquire environmental parameters of a short-range communication area, where the environmental parameters include spectral features and wireless environmental features of the short-range communication area;
a channel determination device 200, configured to select at least one candidate channel according to the spectral features and determine an optimal operating channel from the at least one candidate channel based on the wireless environmental features of the short-range communication area;
a strategy determination device 300, configured to determine an initial channel coding strategy according to state features of the optimal operating channel and adjust the initial channel coding strategy based on the wireless environmental features of the short-range communication area to acquire an optimal channel coding strategy;
a modulation mode determination device 400, configured to input the wireless environmental features of the short-range communication area and the state features of the optimal operating channel into a pre-constructed modulation prediction model to output an optimal signal modulation mode; and
a sending device 500, configured to sequentially and correspondingly perform data coding, signal modulation, and signal sending on data to be sent by using the optimal channel coding strategy, the optimal signal modulation mode, and the optimal operating channel.

This application is described with reference to flowcharts and/or block diagrams of the method, the device (system), and the computer program product according to the embodiments of this application. It should be understood that each process and/or block in the flowcharts and/or the block diagrams, as well as combinations of the processes and/or the blocks in the flowcharts and/or the block diagrams may be implemented by computer program instructions. These computer program instructions may be provided to a general-purpose computer, a dedicated computer, an embedded processor, or a processor of another programmable data processing device to generate a machine, so that an apparatus configured to implement functions specified in one or more processes in the flowcharts and/or one or more blocks in the block diagrams is generated by using instructions executed by the computer or the processor of the another programmable data processing device.

Those of ordinary skill in the art may understand that all or some of the steps in the various methods of the above-mentioned embodiments may be completed by instructing relevant hardware through a program, and the problem may be stored in a computer-readable storage medium. The storage medium includes a read-only memory (ROM), a random access memory (RAM), a programmable read-only memory (PROM), an erasable programmable read only memory (EPROM), a one-time programmable read-only memory (OTPROM), an electrically-erasable programmable read-only memory (EEPROM), a compact disc read-only memory (CD-ROM), or another optical disk memory, disk memory, a magnetic tape memory, or any other computer-readable medium capable of carrying or storing data.

It should be further noted that the terms “include”, “contain”, or any other variations thereof are intended to cover a non-exclusive inclusion, so that a process, a method, a product, or a device that includes a series of elements not only includes those elements, but also includes other elements not expressly listed, or further includes elements inherent to the process, the method, the product, or the device. Without more limitations, an element defined by the phrase “including a . . . ” does not exclude the presence of additional identical elements in the process, the method, the product, or the device that includes the element.

What is claimed is:

1. A data processing method for near-field wireless transmission, wherein the method comprises the following steps:
acquiring environmental parameters of a short-range communication area, wherein the environmental parameters comprise spectral features and wireless environmental features of the short-range communication area,
specifically, acquiring the environmental parameters comprising:
collecting and analyzing the spectral features within the short-range communication area, comprising available frequency bands, spectrum occupancy states, and signal interference intensities; and
measuring and evaluating the wireless environmental features within the short-range communication area, comprising a path loss value of a signal, a multipath effect parameter value of the signal, a level of obstruction of a signal transmission path by an obstacle, and an electromagnetic environment interference intensity;
selecting at least one candidate channel according to the spectral features and determining an optimal operating channel from the at least one candidate channel based on the wireless environmental features of the short-range communication area;
determining an initial channel coding strategy according to state features of the optimal operating channel and adjusting the initial channel coding strategy based on the wireless environmental features of the short-range communication area to acquire an optimal channel coding strategy;
inputting the wireless environmental features of the short-range communication area and the state features of the optimal operating channel into a pre-constructed modulation prediction model to output an optimal signal modulation mode; and
sequentially and correspondingly performing data coding, signal modulation, and signal sending on data to be sent by using the optimal channel coding strategy, the optimal signal modulation mode, and the optimal operating channel.

2. The data processing method for near-field wireless transmission according to claim 1, wherein the step of selecting at least one candidate channel according to the spectral features and determining an optimal operating channel from the at least one candidate channel based on the wireless environmental features of the short-range communication area comprises:
screening out a candidate channel set that meets preset spectrum conditions based on the available frequency bands, the spectrum occupancy states, and the signal interference intensities in the spectral features, wherein the preset spectrum conditions comprise determining whether a channel is available, whether the spectrum occupancy rate of the channel is less than a preset occupancy rate threshold, and whether the signal interference intensity of the channel is less than a preset interference threshold;
performing indicator evaluation on the candidate channel set according to a plurality of evaluation indicators determined by the wireless environmental features, to obtain an evaluation result; and
determining the optimal operating channel from the candidate channel set through a weighted scoring method based on the evaluation result of the wireless environmental features.

3. The data processing method for near-field wireless transmission according to claim 2, wherein acquiring wireless environmental features comprises:
measuring and calculating a path loss value for each candidate channel, wherein the path loss value is negatively correlated with a channel score;
analyzing a multipath effect parameter value for each candidate channel, wherein the multipath effect parameter value is negatively correlated with the channel score;
simulating a signal propagation path of each candidate channel by using a geographic information system in combination with a building layout map, and evaluating a level of obstruction of a signal transmission path by an obstacle, wherein the obstruction level is negatively correlated with the channel score; and
monitoring an electromagnetic environment interference intensity for each candidate channel, wherein the electromagnetic environment interference intensity is negatively correlated with the channel score.

4. The data processing method for near-field wireless transmission according to claim 3, wherein the determining an optimal operating channel from the candidate channel set through a weighted scoring method based on the evaluation result of the wireless environmental features comprises:
pre-allocating a corresponding weight coefficient for each evaluation indicator;
for each candidate channel, calculating a weighted score of the candidate channel using the following formula:
$${S}_{i} = {ω}_{1} \cdot {P}_{i} + {ω}_{2} \cdot {M}_{i} + {ω}_{3} \cdot {O}_{i} + {ω}_{4} \cdot {I}_{i}$$
wherein Sᵢ represents a weighted score of an i-th candidate channel, Pᵢ represents a path loss value of the i-th candidate channel, Mᵢ represents a multipath effect parameter value of the i-th candidate channel, Oᵢ represents an obstruction level of the i-th candidate channel, Iᵢ represents an electromagnetic environment interference intensity of the i-th candidate channel, and ω₁, ω₂, ω₃, and ω₄ respectively represent weight coefficients for the path loss value, the multipath effect parameter value, the obstruction level, and the electromagnetic environment interference intensity; and
selecting a channel with the highest weighted score from all the candidate channels as the optimal operating channel.

5. The data processing method for near-field wireless transmission according to claim 4, wherein the step of determining an initial channel coding strategy according to state features of the optimal operating channel and adjusting the initial channel coding strategy based on the wireless environmental features of the short-range communication area to acquire an optimal channel coding strategy comprises:
preliminarily selecting a combination of coding rates and coding lengths from a preset mapping table as the initial channel coding strategy based on spectrum efficiency, a bit error rate, and signal stability of the optimal operating channel, wherein the preset mapping table is pre-established according to an empirical relationship between channel state features and coding parameters; and
adjusting a coding rate and a coding length of the initial channel coding strategy according to the path loss value, the multipath effect parameter value, the obstruction level, and the electromagnetic environment interference intensity to obtain the optimal channel coding strategy with the adjusted coding rate and coding length.

6. The data processing method for near-field wireless transmission according to claim 5, wherein the coding rate and the coding length are adjusted according to the following formulas:
$${R}_{2} = {R}_{1} \cdot ( 1 - {α}_{1} \cdot \frac{P}{{P}_{max}} - {α}_{2} \cdot \frac{M}{{M}_{max}} - {α}_{3} \cdot \frac{O}{{O}_{max}} - {α}_{4} \cdot \frac{1}{{I}_{max}} )$$
$${L}_{2} = {L}_{1} \cdot ( 1 + {β}_{1} \cdot \frac{P}{{p}_{max}} + {β}_{2} \cdot \frac{M}{{M}_{max}} + {β}_{3} \cdot \frac{O}{{O}_{max}} + {β}_{4} \cdot \frac{1}{{I}_{max}} )$$
wherein R₂ and R₁ represent coding rates before and after the adjustment respectively, L₂ and L₁ represent coding lengths before and after the adjustment respectively, P, M, O, and I represent the path loss value, the multipath effect parameter value, the obstruction level, and the electromagnetic environment interference intensity respectively, with values equal to Pᵢ, Mᵢ, Oᵢ, and Iᵢ respectively, α₁, α₂, α₃, and α₄ represent adjustment coefficients corresponding to the coding rate adjustment, β₁, β₂, β₃, and β₂ represent adjustment coefficients corresponding to the coding length adjustment, and Pₘₐₓ, Mₘₐₓ, Oₘₐₓ, and Iₘₐₓ are maximum allowable values of the path loss value, the multipath effect parameter value, the obstruction level, and the electromagnetic environment interference intensity, respectively.

7. The data processing method for near-field wireless transmission according to claim 6, wherein the step of inputting the wireless environmental features of the short-range communication area and the state features of the optimal operating channel into a pre-constructed modulation prediction model to output an optimal signal modulation mode comprises:
inputting the wireless environmental features and the state features of the optimal operating channel as an input vector into the pre-constructed modulation prediction model, and according to the inputted input vector, calculating, by the modulation prediction model, an applicable score for each modulation mode, and selecting the modulation mode with the highest score as the optimal signal modulation mode, wherein the modulation prediction model is a machine learning model that learns a mapping relationship between the wireless environmental features, the channel state features, and the optimal signal modulation mode.

8. The data processing method for near-field wireless transmission according to claim 7, wherein the step of sequentially and correspondingly performing data coding, signal modulation, and signal sending on data to be sent by using the optimal channel coding strategy, the optimal signal modulation mode, and the optimal operating channel comprises:
coding the data to be sent according to the determined optimal channel coding strategy;
converting the coded data into a signal form suitable for transmission on the selected optimal operating channel by using the determined optimal signal modulation mode; and
sending a modulated signal to a receiving terminal through the optimal operating channel.
